(19) United States
(12) Patent Application Publication
(10) Pub. No.: US 2010/0150061 A1
(43) Pub. Date: Jun. 17, 2010

(54) Device and method for arranging access point in wireless location

(75) Inventors: Seong Yun Cho, Daejeon (KR); Byung Doo Kim, Daejeon (KR); Youngsu Cho, Seoul (KR); Sung Jo Yun, Daejeon (KR); Sun-Joong Kim, Daejeon (KR); Wan Sik Choi, Daejeon (KR); Jong-Hyun Park, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/461,662

(22) Filed: Aug. 20, 2009

(30) Foreign Application Priority Data
Dec. 11, 2008 (KR) 10-2008-0126103

(51) Int. Cl. H04W 40/00

(52) U.S. Cl. 370/328

(57) ABSTRACT

Provided are an access point arrangement device and a method for wireless location determination. An access point is arranged on a numerical map, received signal strength of a signal received from the access point for each grid point is calculated, and DOP and position error per grid point are calculated by using the received signal strength per grid point. It is determined whether to rearrange the currently arranged access point based on a ratio of a grid point with DOP less than a threshold value for entire grid points on the numerical map and a ratio of a grid point with a position error that is less than a threshold value.

### CROSS-REFERENCE TO RELATED APPLICATION

This application claims priority to and the benefit of Korean Patent Application No. 10-2008-0126103 filed in the Korean Intellectual Property Office on Dec. 11, 2008, the entire contents of which are incorporated herein by reference.

### BACKGROUND OF THE INVENTION

(a) Field of the Invention

The present invention relates to a method and device for arranging access points for a wireless location. Particularly, the present invention relates to a method and device for arranging access points for a wireless location in a room.

(b) Description of the Related Art

In general, a telematics/local based service (LBS) navigation system is configured by using a receiver for a satellite-based positioning system such as the global position system (GPS). For example, the navigation system provides services such as path guidance and local information by using vehicle location information acquired through a GPS receiver. The GPS receiver has a problem of failing to provide position information because of weak satellite signals in a room, tunnel, underground parking lot, and urban areas.

Accordingly, interior location capacities have been actively researched so as to provide various interior position-based services, and particularly, the wireless location schemes using wireless communication devices such as the wireless local area network (WLAN), the ultra wide band (UWB), the chirp spread spectrum (CSS), the Zigbee, and the Bluetooth have been researched. The wireless location schemes perform location determination by using a GPS satellite in the field and perform the location determination by using an access point (AP) for wireless communication in the room. For this, it is important to arrange the AP to be advantageous in terms of location as well as wireless communication.

However, the existing AP that is installed is arranged in consideration of wireless communication rather than location. Therefore, in order to perform location determination by using the existing AP, it is required to arrange the AP to be advantageous for location determination. When the AP is randomly arranged to perform location determination, it is difficult to estimate location accuracy per position, and much time is spent and much and difficulty occurs in arranging the AP through real tests. Accordingly, methods for arranging the AP based on simulation have been proposed. However, these methods generally arrange the AP mainly for the AP coverage, and no standards for arranging the AP for location determination have been prepared.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and device for efficiently arranging an AP for wireless location determination in a room.

An exemplary embodiment of the present invention provides a device for arranging access points for wireless location determination including: a received signal strength calculator for calculating an RSS of a signal received from at least one access point per grid point on a numerical map; a dilution of precision comparator for calculating dilution of precision per grid point by using the received signal strength generated per grid point, and calculating a first ratio of a grid point with dilution of precision that is less than a first threshold value for entire grid points on the numerical map; and an arranger for rearranging the at least one access point on the numerical map when the first ratio is less than a second threshold value.

Another embodiment of the present invention provides a method for arranging access points for wireless location determination including: arranging at least one access point on a numerical map; calculating a position error that can be generated for each grid point on the numerical map; generating a first ratio of a grid point with a position error that is less than a first threshold value for the entire grid points on the numerical map; and rearranging the at least one access point on the numerical map when the first ratio is less than a second threshold value.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a configuration diagram of an AP arrangement device for wireless location determination according to an exemplary embodiment of the present invention.

FIG. 2 shows a flowchart of an AP arrangement method according to an exemplary embodiment of the present invention.

FIG. 3 exemplifies AP arrangement on a numerical map based on an AP arrangement method according to an exemplary embodiment of the present invention.

FIG. 4 shows an example of received signal strength per GP generated based on an AP arrangement method according to an exemplary embodiment of the present invention.

FIG. 5 shows an example of a number of AP's that can be received per GP by using the received signal strength per GP generated based on an AP arrangement method according to an exemplary embodiment of the present invention.

FIG. 6 shows an exemplar of DOP per GP generated based on an AP arrangement method according to an exemplary embodiment of the present invention.

FIG. 7 shows an example of position errors per GP generated based on an AP arrangement method according to an exemplary embodiment of the present invention.

FIG. 8 shows a case for rearranging the AP on a numerical map based on an AP arrangement method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A device and method for arranging access points for wireless location determination according to an exemplary embodiment of the present invention will now be described with reference to accompanying drawings.

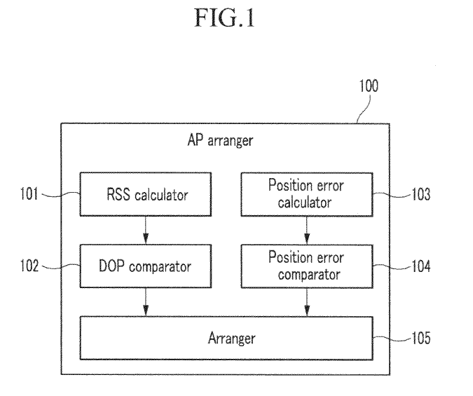

FIG. 1 shows a configuration diagram of an access point (AP) arrangement device for wireless location determination according to an exemplary embodiment of the present invention.

Referring to FIG. 1, the AP arrangement device 100 includes a received signal strength calculator 101, a dilution of precision (DOP) comparator 102, a position error calculator 103, a position error comparator 104, and an arranger 105.

The received signal strength calculator 101 calculates the received signal strength of each AP arranged on the numerical map for each grid point (GP) on the numerical map. That is, the received signal strength calculator 101 calculates the received signal strength when each GP receives the signal output by the AP. For this, the numerical map, the position coordinates of AP and GP, and the electric wave attenuation model are used.

Here, the numerical map can be stored/readable/writable in the file format, and the position coordinates (horizontal position coordinate and vertical position coordinate) of each AP can be set. Also, each GP represents a point that is set in a lattice with regular intervals on the numerical map, and it is set as a crossing position on the numerical map. The signal output by the AP is attenuated by walls or furniture in the room, and the GP receives the attenuated signal. Attenuation of the signal can be estimated by using an electric wave attenuation model such as the Ray tracing model. Therefore, the received signal strength from each AP per GP can be estimated by using the electric wave attenuation model.

The DOP comparator 102 calculates the DOP for each GP as expressed in Equation 1 by using the received signal strength per GP generated by the received signal strength calculator 101 and the number of AP's for receiving the signal at each GP.

DOP(P)={square root over (trace((H^{T}WH)⁻¹))} (Equation 1)

Here, P represents the position coordinate ([x y]^{T}) of the GP, and trace( ) represents the sum of diagonal components of the matrix. Further, W representing a weight value matrix is calculated by using the inverse distance weight (IDW) and received signal strength of each AP that is received at the corresponding GP, and W can be given as a unit matrix when no weight value is applied.

Also, H is expressed in Equation 2.

$$H = [ \begin{matrix}\frac{x - {x}_{1}}{{r}_{1}} & \frac{y - {y}_{1}}{{r}_{1}} \\ \frac{x - {x}_{2}}{{r}_{2}} & \frac{y - {y}_{2}}{{r}_{2}} \\ ⋮ & ⋮ \\ \frac{x - {x}_{n}}{{r}_{n}} & \frac{y - {y}_{n}}{{r}_{n}}\end{matrix} ] \qquad ( Equation 2 )$$

Here, [xᵢ yᵢ]^{T} indicates the position coordinate of the i-th AP, and rᵢ=\sqrt{(x−xᵢ)²+(y−yᵢ)²}.

As described, when the DOP per GP is calculated, the DOP comparator 102 stores the DOP per GP together with the position coordinate of the corresponding GP in a database.

The DOP comparator 102 compares the DOP per GP with a specific threshold value, calculates the number of GP's with the DOP that is less than a threshold value on the numerical map, and calculates the ratio % of the GP with the DOP that is less than the threshold value for the entire GP's.

The position error calculator 103 calculates the position error that can be generated by each GP when location is performed. For this, the position error calculator 103 includes an error in the measured value calculated for performing location, and then performs the location by using a location scheme such as the trilateration or the fingerprint. Here, the error included in the measured value represents white noise and it is included in the measured value in the format of a random variable. The position error calculator 103 performs location determination many times by using the measured value including the error, and then finally calculates the position error that may be generated at each GP. For example, the position error calculator 103 performs location determination 100 times to acquire 100 errors generated by the GP, and shows the position error in the manner of probability by using the acquired error.

The position error comparator 104 compares the position error per GP acquired by the position error calculator 103 with a predetermined threshold value, calculates the number of GP's showing the position error that is less than the threshold value from among the entire GP's on the numerical map, and calculates the ratio % of the GP with the position error that is less than the threshold value for the entire GP's.

The arranger 105 determines the position of the current AP on the numerical map to be the final position when the ratio % of the GP with the DOP that is less than the threshold value for the entire GP's generated by the DOP comparator 102 is greater than a predetermined threshold value Threshold1 and the ratio % of the GP with the position error that is less than the threshold value for the entire GP's generated by the position error comparator 104 is greater than a predetermined threshold value Threshold2. On the other hand, the arranger 105 rearranges the AP on the numerical map when the ratio % of the GP with the DOP that is less than the threshold value for the entire GP's is less than the threshold value Threshold1 or the ratio % of the GP with the position error that is less than the threshold value for the entire GP's is less than the threshold value Threshold2.

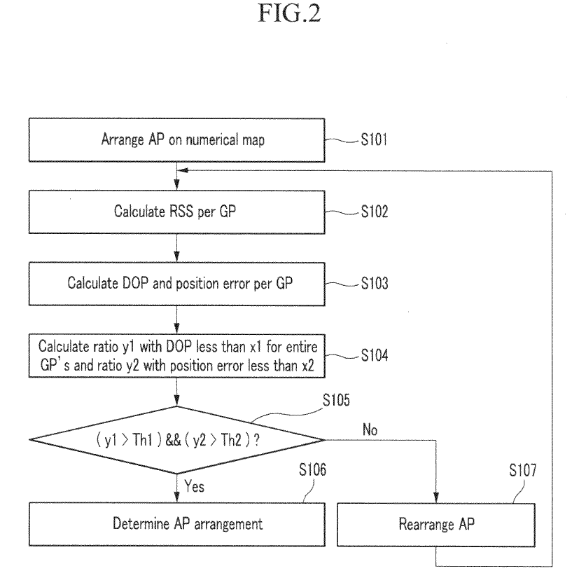

An AP arrangement method according to an exemplary embodiment of the present invention will be described with reference to FIG. 2 to FIG. 8.

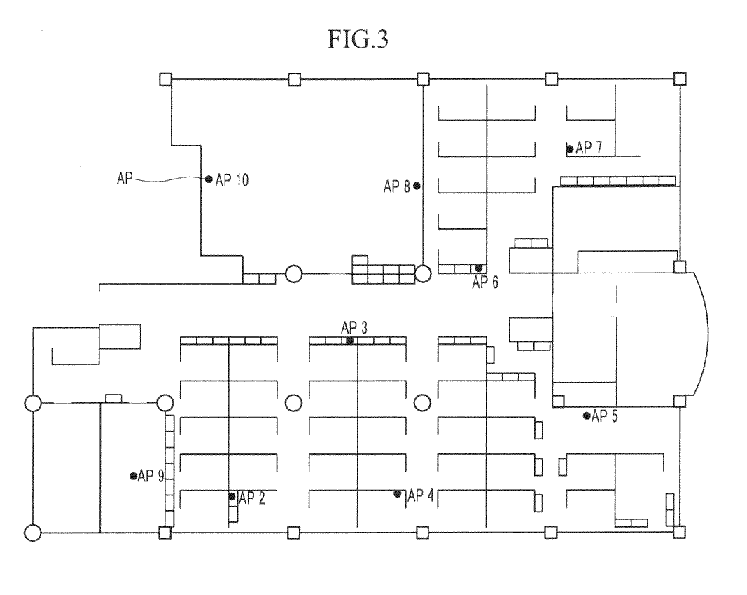

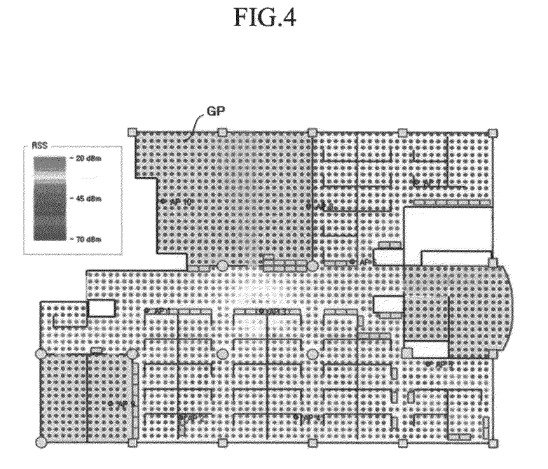

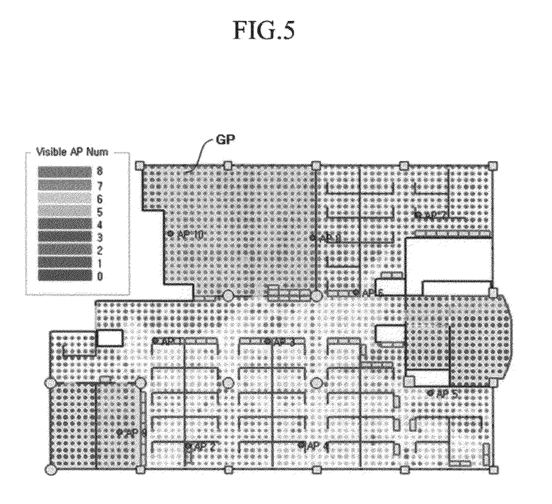

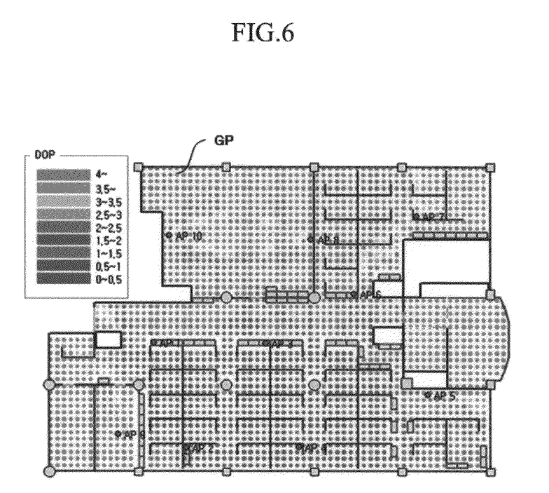

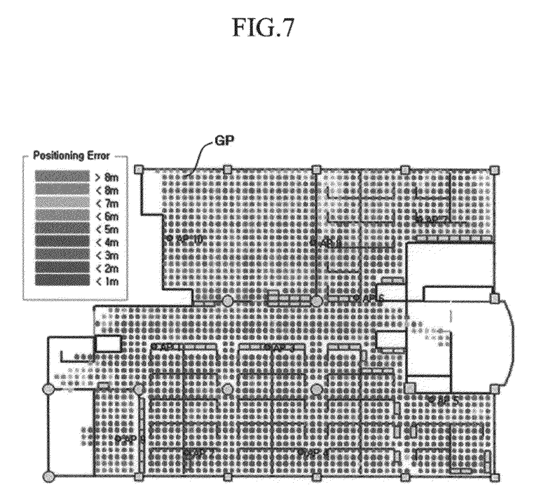

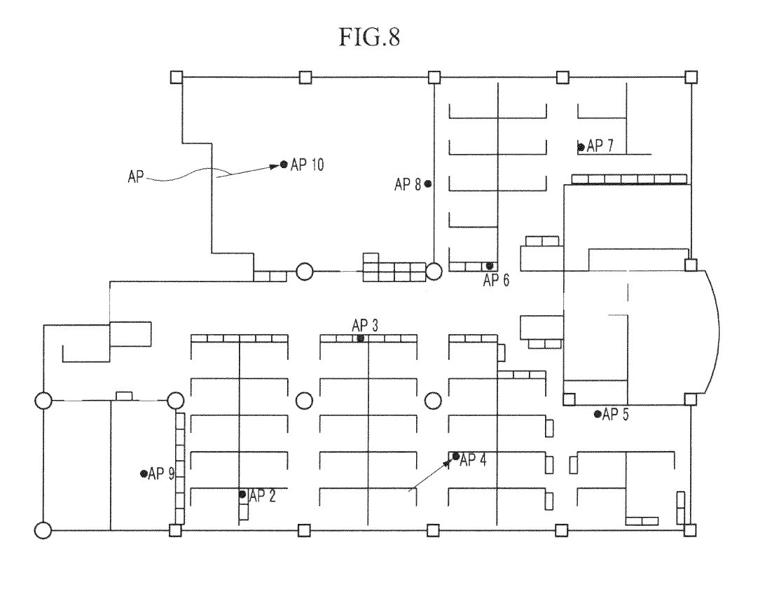

FIG. 2 shows a flowchart of an AP arrangement method according to an exemplary embodiment of the present invention. FIG. 3 exemplifies an AP arrangement on a numerical map based on an AP arrangement method according to an exemplary embodiment of the present invention, and FIG. 4 shows an example of a received signal strength per GP generated based on an AP arrangement method according to an exemplary embodiment of the present invention. FIG. 5 shows an example of a number of AP's that can be received per GP by using the received signal strength per GP generated based on an AP′ arrangement method according to an exemplary embodiment of the present invention, FIG. 6 shows an exemplar of DOP per GP generated based on an AP arrangement method according to an exemplary embodiment of the present invention, and FIG. 7 shows an example of position errors per GP generated based on an AP arrangement method according to an exemplary embodiment of the present invention. FIG. 8 shows a case for rearranging the AP on a numerical map based on an AP arrangement method according to an exemplary embodiment of the present invention.

Referring to FIG. 2 and FIG. 3, the AP arrangement device 100 arranges the AP's AP1 to AP10 on the numerical map through the arranger 105 (S101). Here, the places where in the AP can be provided on the numerical map can be a wall or furniture, and the AP arrangement device 100 positions the AP at the initial position. The initial position of the AP represents the position where the AP can be installed, and it can be set by the user. The arranger 105 arranges the AP's and stores the position coordinates of the AP's in the database.

The AP arrangement device 100 calculates the received signal strength from each AP per GP on the numerical map through the received signal strength calculator 101 (S102), and generates the number of AP's for receiving the signal for each GP by using the received signal strength. Here, as shown in FIG. 4 and FIG. 5, the GP represents the point that is set as a lattice with regular intervals on the numerical map, FIG. 4 showing the example of received signal strengths (RSS) per GP in color, and FIG. 5 showing the example of the number of AP's for receiving the signal for each GP in color.

Referring to FIG. 2, the AP arrangement device 100 generates the DOP for each GP by using the RSS per GP through the DOP comparator 102 and the number of AP's for each GP, and generates the position error that can be generated for each GP through the position error calculator 103 (S103). FIG. 6 shows an example of the DOP per GP generated by using the RSS per GP and the number of AP's that can be received per GP in color, and FIG. 7 shows an example of the position error that can occur per GP in color.

Referring to FIG. 2, the AP arrangement device 100 having generated the DOP per GP and the position error generates the ratio y1 of the GP with the DOP that is less than a predetermined threshold value x1 for the entire GP's shown on the numerical map and the ratio y2 of the GP with the position error that is less than a predetermined threshold value x2 through the DOP comparator 102 and the position error comparator 104 (S104). The AP arrangement device 100 compares the ratio y1 of the GP with the DOP that is less than the threshold value x1 for the entire GP's and the ratio y2 of the GP with the phase error that is less than the threshold value x2 with respective threshold values Th1 and Th2 (S106).

According to the comparison result, when the ratio y1 is greater than the threshold value Th1 and the ratio y2 is greater than the threshold value Th2, the current AP arrangement is determined to be appropriate for location and the AP arrangement on the numerical map is determined to be the current position (S107).

On the contrary, when the ratio y1 is less than the threshold value Th1 or the ratio y2 is less than the threshold value Th2, the current AP arrangement is determined to be not appropriate for location to determine AP rearrangement (S108), and repeats the above-noted AP arrangement process (S102 to S105).

FIG. 8 shows an example of rearranging the AP on the numerical map based on the AP arrangement method according to an exemplary embodiment of the present invention.

FIG. 8 shows AP rearrangement by using arrows. The AP has been rearranged in the exemplary embodiment of the present invention, and if needed, a new AP can be added on the numerical map or the arranged AP can be deleted.

According to the embodiment of the present invention, the reference for arranging the AP is provided by a proposed method for using dilution of precision of each grid point and position error so as to find an optimal arrangement of the AP for wireless location determination in the room, and consumption of time and effort for arranging the AP is reduced by determining AP arrangement on the basis of simulation.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A device for arranging access points for wireless location determination, comprising:
a received signal strength calculator for calculating an RSS of a signal received from at least one access point per grid point on a numerical map;
a dilution of precision comparator for calculating dilution of precision per grid point by using the received signal strength generated per grid point, and calculating a first ratio of grid points with dilution of precision that is less than a first threshold value for entire grid points on the numerical map; and
an arranger for rearranging the at least one access point on the numerical map when the first ratio is less than a second threshold value.

2. The device of claim 1, wherein the device further includes:
a position error calculator for calculating a position error that can be generated per grid point; and
a position error comparator for calculating a second ratio of grid points with the position error that is less than a third threshold value for the entire grid points,
wherein the arranger rearranges the at least one access point on the numerical map when the second ratio is less than a fourth threshold value.

3. The device of claim 2, wherein
the arranger determines the current position of the at least one access point as a final position when the first ratio is greater than the second threshold value and the second ratio is greater than the fourth threshold value.

4. The device of claim 2, wherein
the position error calculator acquires the position error by expressing the error acquired by performing location determination using a measured value including the error in the probabilistic manner.

5. The device of claim 1, wherein
the received signal strength calculated per grid point is estimated based on position coordinates of the at least one access point, position coordinates for each grid point, and an electric wave attenuation model.

6. The device of claim 5, wherein
the numerical map can be stored, read, and written in the file format, and a position coordinate of the at least one access point can be set.

7. A method for arranging access points for wireless location determination, comprising:
arranging at least one access point on a numerical map;
calculating a position error that can be generated for each grid point on the numerical map;
generating a first ratio of a grid point with a position error that is less than a first threshold value for the entire grid points on the numerical map; and
rearranging the at least one access point on the numerical map when the first ratio is less than a second threshold value.

8. The method of claim 7, further including;
calculating received signal strength of a signal received from the at least one access point for each grid point;
calculating dilution of precision per grid point by using the received signal strength generated per grid point;
generating a second ratio of a grid point with dilution of precision that is less than a third threshold value for the entire grid points; and
rearranging the at least one access point on the numerical map when the second ratio is less than a fourth threshold value.

9. The method of claim 8, further including
determining a current position of the at least one access point as a final position when the first ratio is greater than the second threshold value and the second ratio is greater than the fourth threshold value.

10. The method of claim 9, wherein
the calculating of a received signal strength includes
calculating a position coordinate of the at least one access point, and a received signal strength of a signal received from the at least one access point per grid point.

11. The method of claim 9, wherein
the calculating of dilution of precision per grid point includes
calculating dilution of precision per grid point by using the received signal strength calculated per grid point, the number of access points for receiving the signal for each grid point, and an inverse distance, weight.
